(19) United States
(12) Patent Application Publication
(10) Pub. No.: US 2020/0074864 A1
(43) Pub. Date: Mar. 5, 2020

(54) SYSTEM TO REDUCE THE RATE OF REDUNDANT VEHICLE DATA

(71) Applicant: GM GLOBAL TECHNOLOGY OPERATIONS LLC, Detroit, MI (US)

(72) Inventor: Donal McErlean, County Clare (IE)

(73) Assignee: GM GLOBAL TECHNOLOGY OPERATIONS LLC, Detroit, MI (US)

(21) Appl. No.: 16/121,527

(22) Filed: Sep. 4, 2018

(51) Int. Cl. G08G 1/00; G08G 1/01

(52) U.S. Cl. CPC G08G 1/20; G08G 1/0112; G08G 1/0129

(57) ABSTRACT

Methods and systems are provided that include obtaining, via a transceiver, location data from a plurality of vehicles pertaining to a location of each of the vehicles, from transmission from the vehicles; determining, via a processor, a group of the vehicles that are expected to be disposed within a particular region at a particular time; calculating, via the processor, a density of vehicles for the particular region for the particular time, based on the determined group of vehicles; selecting, via the processor, a subset of the group of vehicles for continued transmission of data, based on the density of vehicles; and providing instructions, via the processor for transmission via the transceiver, for selective continuing or discontinuing of subsequent transmission of location data from certain of the group of vehicles, based on whether each of the group of the plurality of vehicles is part of the subset.

### TECHNICAL FIELD

The technical field generally relates to the field of vehicles, and, more specifically, to methods and systems for monitoring a fleet of vehicles using location data.

### INTRODUCTION

Many vehicles include one or more systems, such as location systems, telematics and global positioning system (GPS) modules, and so on, that provide information regarding the location of the vehicle. Certain vehicles may be part of a fleet of vehicles that are monitored using location data from the respective systems. Such monitoring of a plurality of vehicles may require significant data and/or other resources.

Accordingly, it may be desirable to provide methods and systems for monitoring a plurality of vehicles, for example that may potentially conserve data and/or other resources, for example by reducing minimizing data that need to be transmitted for estimating traffic conditions for a fleet of vehicles.

Furthermore, other desirable features and characteristics of the present invention will become apparent from the subsequent detailed description and the appended claims, taken in conjunction with the accompanying drawings.

### SUMMARY

In one embodiment, a method is provided that includes: obtaining, via a transceiver, location data from a plurality of vehicles pertaining to a location of each of the vehicles, from transmission from the plurality of vehicles; determining, via a processor, a group of the plurality of vehicles that are expected to be disposed within a particular region at a particular time; calculating, via the processor, a density of vehicles for the particular region for the particular time, based on the determined group of vehicles; selecting, via the processor, a subset of the group of the plurality of vehicles for continued transmission of data, based on the density of vehicles; and providing instructions, via the processor for transmission via the transceiver, for selective continuing or discontinuing of subsequent transmission of location data from certain of the group of the plurality of vehicles, based on whether each of the group of the plurality of vehicles is part of the subset.

Also in one embodiment, the method further includes: obtaining historical data as to travel routes taken by the plurality of vehicles at previous times; and predicting, via the processor, future locations of the plurality of vehicles at a future point time based on the location data and the historical data; wherein the step of determining the group of the plurality of vehicles that are expected to be disposed within the particular region at the particular time includes determining, via the processor, the group of the plurality of vehicles that are expected to be disposed within the particular region at the particular time, based on the predicting of the future locations.

Also in one embodiment, the method further includes: obtaining routing requests for the plurality of vehicles; wherein the step of determining the group of the plurality of vehicles that are expected to be disposed within the particular region at the particular time includes determining, via the processor, the group of the plurality of vehicles that are expected to be disposed within the particular region at the particular time, based on the obtained routing requests.

Also in one embodiment, the step of selecting the subset includes selecting, via the processor, the group of the plurality of vehicles for continued transmission of data, at random, based on the density of vehicles, such that a predetermined number of vehicles continues the transmission of data for the particular region for the particular time, without redundant transmission of vehicle beyond the predetermined number of vehicles.

Also in one embodiment, the step of providing instructions includes: providing instructions, via the processor using the transceiver, for all vehicles in the group that are not part of the subset, for selective discontinuing of subsequent transmission of location data.

Also in one embodiment, the step of providing instructions includes: providing instructions, via the processor for transmission via the transceiver, for all vehicles in the group that are part of the subset, for selective continuing of subsequent transmission of location data.

Also in one embodiment, the obtaining, determining, calculating, selecting, and providing instructions are provided via a computer system that is part of a central server that is remote from and in communication with the plurality of vehicles.

Also in one embodiment, the obtaining, determining, calculating, selecting, and providing instructions are provided via a computer system that is onboard one of the plurality of vehicles.

In one embodiment, a system is provided that includes: a data module configured to obtain, via a transceiver, location data from a plurality of vehicles pertaining to a location of each of the vehicles, from transmission from the plurality of vehicles; and a processing module configured to: determine, via a processor, a group of the plurality of vehicles that are expected to be disposed within a particular region at a particular time; calculate, via the processor, a density of vehicles for the particular region for the particular time, based on the determined group of vehicles; select, via the processor, a subset of the group of the plurality of vehicles for continued transmission of data, based on the density of vehicles; and provide instructions, via the processor for transmission via the transceiver, for selective continuing or discontinuing of subsequent transmission of location data from certain of the group of the plurality of vehicles, based on whether each of the group of the plurality of vehicles is part of the subset.

Also in one embodiment, the data module is configured to obtain historical data as to travel routes taken by the plurality of vehicles at previous times; and the processing module is configured to: predict, via the processor, future locations of the plurality of vehicles at a future point time based on the location data and the historical data; and determine, via the processor, the group of the plurality of vehicles that are expected to be disposed within the particular region at the particular time, based on the predicting of the future locations.

Also in one embodiment, the data module is configured to obtain routing requests for the plurality of vehicles; and the processing module is configured to determine, via the processor, the group of the plurality of vehicles that are expected to be disposed within the particular region at the particular time, based on the obtained routing requests.

Also in one embodiment, the processing module is configured to select, via the processor, the group of the plurality of vehicles for continued transmission of data, at random, based on the density of vehicles, such that a predetermined number of vehicles continues the transmission of data for the particular region for the particular time, without redundant transmission of vehicle beyond the predetermined number of vehicles.

Also in one embodiment, the processing module is configured to provide instructions, via the processor for transmission via the transceiver, for all vehicles in the group that are not part of the subset, for selective discontinuing of subsequent transmission of location data.

Also in one embodiment, the processing module is configured to provide instructions, via the processor for transmission via the transceiver, for all vehicles in the group that are part of the subset, for selective continuing of subsequent transmission of location data.

Also in one embodiment, wherein the data module and the processing module are part of a computer system that is part of a central server that is remote from and in communication with the plurality of vehicles.

Also in one embodiment, the data module and the processing module are part of a computer system that is onboard one of the plurality of vehicles.

In one embodiment, a computer system is provided that includes: a transceiver disposed on a remote server that is remote from a plurality of vehicles and configured to obtain location data from the plurality of vehicles pertaining to a location of each of the vehicles, from transmission from the plurality of vehicles; and a processor disposed on the remote server and configured to: determine a group of the plurality of vehicles that are expected to be disposed within a particular region at a particular time; calculate a density of vehicles for the particular region for the particular time, based on the determined group of vehicles; select a subset of the group of the plurality of vehicles for continued transmission of data, based on the density of vehicles; and provide instructions for selective continuing or discontinuing of subsequent transmission of location data from certain of the group of the plurality of vehicles, based on whether each of the group of the plurality of vehicles is part of the subset; wherein the transceiver is further configured to transmit the instructions from the processor to the plurality of vehicles.

Also in one embodiment, the transceiver is configured to obtain historical data as to travel routes taken by the plurality of vehicles at previous times; and the processor is configured to: predict future locations of the plurality of vehicles at a future point time based on the location data and the historical data; and determine the group of the plurality of vehicles that are expected to be disposed within the particular region at the particular time, based on the predicting of the future locations.

Also in one embodiment, the processor is configured to select the group of the plurality of vehicles for continued transmission of data, at random, based on the density of vehicles, such that a predetermined number of vehicles continues the transmission of data for the particular region for the particular time, without redundant transmission of vehicle beyond the predetermined number of vehicles.

Also in one embodiment, the processor is configured to: provide first instructions for all vehicles in the group that are not part of the subset, for selective discontinuing of subsequent transmission of location data; and provide second instructions for all vehicles in the group that are part of the subset, for selective continuing of subsequent transmission of location data; and the transceiver is configured to transmit the first instructions and the second instructions to the plurality of vehicles.

### DESCRIPTION OF THE DRAWINGS

The present disclosure will hereinafter be described in conjunction with the following drawing figures, wherein like numerals denote like elements, and wherein:

FIG. 1 is a functional diagram of a system including a fleet of vehicles and a remote server that monitors and controls the vehicles using location data, in accordance with exemplary embodiments;

FIG. 2 is a functional diagram of modules of a computer system for monitoring and controlling a fleet of vehicles using location data, and that can be implemented in connection with the remote server and/or one or more of the vehicles of the system of FIG. 1, in accordance with exemplary embodiments; and

FIG. 3 is a flowchart of a process for controlling and monitoring a plurality of vehicles using location data, and that can be implemented in connection with the system, modules, and components of FIGS. 1 and 2, in accordance with an exemplary embodiment.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

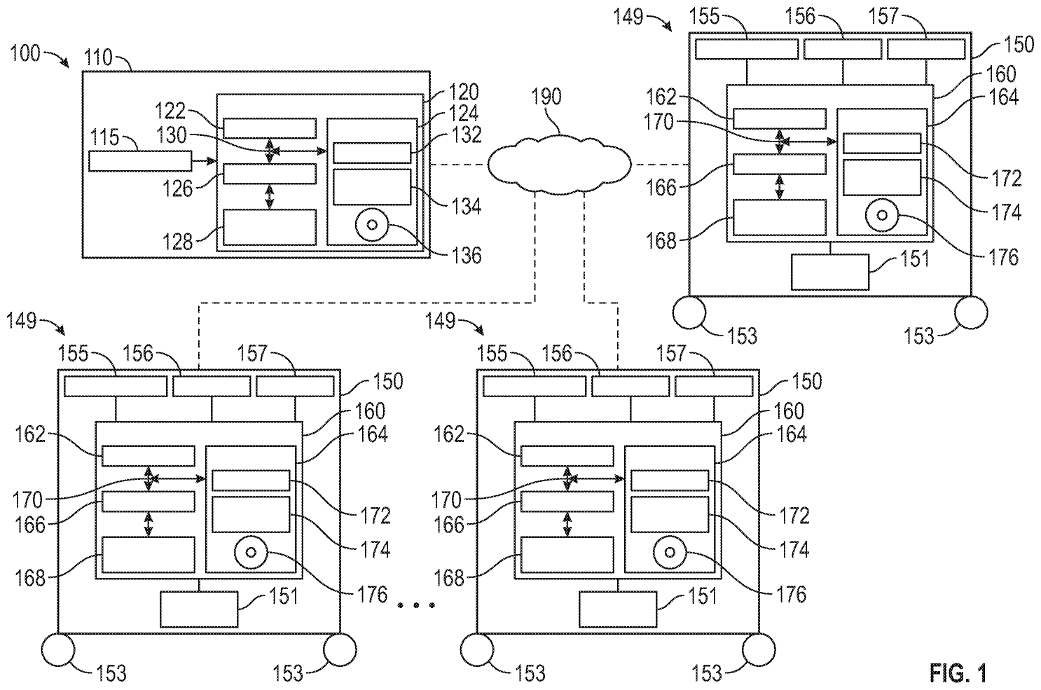

FIG. 1 illustrates a system 100 including a remote server 110 and a fleet 149 of vehicles 150, in accordance with exemplary embodiments. In various embodiments, the vehicles 150 are monitored and controlled using location data, for example as described in greater detail below.

As depicted in FIG. 1, the remote server 110 and the vehicles 150 communicate via one or more wireless communications networks 190. In various embodiments, the wireless communications networks 190 comprise one or more cloud-based networks, for example using wide area networking or Internet based technologies, and/or one or more cellular, satellite, and/or other wireless communications technologies.

In various embodiments, the vehicle fleet 149 may comprise a fleet of taxis, school buses, other transport buses or vans, delivery vehicles, police vehicles, military vehicles, and/or any number of other different types of fleets 149 of vehicles 150 and/or other types of mobile platforms. In certain embodiments, each vehicle 150 comprises an automobile, for example such as a sedan, bus, truck, sport utility vehicle (SUV), or other type of automobile. In other embodiments, the vehicles 150 may comprise one or more other types of vehicles (e.g., marine vehicles, locomotives, aircraft, spacecraft, and other vehicles), and/or other mobile platforms, and/or components thereof.

Also in various embodiments, the remote server 110 monitors and controls the fleet 149 of vehicles 150 using location data obtained from the vehicles 150. As described in greater detail below, in various embodiments the remote server 110 provides routing instructions and traffic information, among other services, to the vehicles 150 in the fleet 149. Also in various embodiments, the remote server 110 monitors movement of the vehicles 150 in the fleet 149, and controls data transmissions by the vehicles 150 to conserve data and/or other resources based on traffic densities in particular regions (e.g., in particular road segments), for example to reduce or eliminate redundancies in the transmission of data by the vehicles 150 in the fleet 149. Also, as used herein, the term “location data” refers to any number of different types of navigation data, satellite-based data (e.g., from a global positioning system (GPS)), sensor data (e.g., from cameras radar, LIDAR, sonar, and/or other vehicle sensors), and/or other data pertaining to a geographic position and/or location of the vehicle 150, and/or related parameters, including GPS probe data, GPS trace data, navigation system data, and/or other types of location data. In addition, other data that may be obtained and/or recorded may include a vehicle's bearing, speed, acceleration, and timestamp data, among other possible data.

As depicted in FIG. 1, in various embodiments, the remote server 110 includes a transceiver 115 and a computer system 120. In various embodiments, the transceiver 115 is utilized to communicate with the vehicles 150 of the fleet 149 via the communications network 190. For example, in various embodiments, the transceiver 115 receives location data from the vehicles 150, and transmits instructions to the vehicles 150 with respect to routing and data transmissions (including as to whether the vehicle 150 should continue or discontinue data transmissions), along with traffic information and/or other services for the vehicles 150.

In various embodiments, the computer system 120 is coupled to the transceiver 115, and controls operation thereof. Also in various embodiments, the computer system 120 controls operation of the remote server 110, and monitors and controls the fleet 149 of vehicles 150 using the location data. In certain embodiments, the computer system 120 implements steps of the process 300 described further below (either alone or in combination with one or more respective computer systems 160 of the vehicles 150) in monitoring and controlling the vehicles 150 using the location data, including the conservation of data and/or other resources based on controlling of subsequent data transmissions of the vehicles 150 based on traffic densities for a particular region (e.g., for a particular road segment).

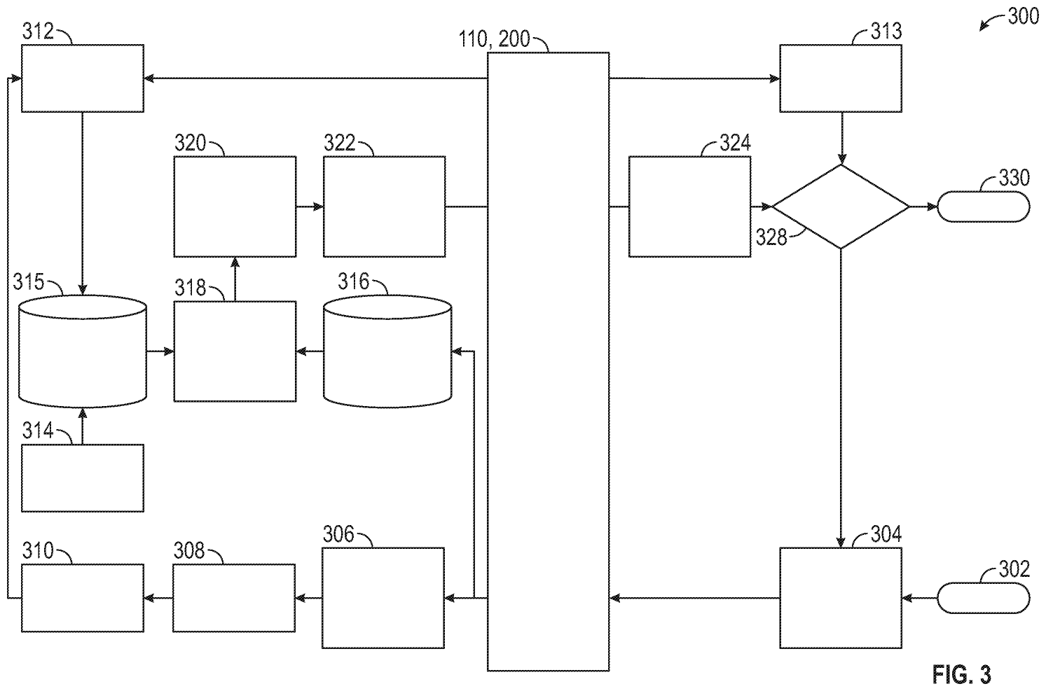

In the depicted embodiment, the computer system 120 of the remote server 110 includes a processor 122, a memory 124, an interface 126, a storage device 128, and a bus 130. The processor 122 performs the computation and control functions of the computer system 120, and may comprise any type of processor or multiple processors, single integrated circuits such as a microprocessor, or any suitable number of integrated circuit devices and/or circuit boards working in cooperation to accomplish the functions of a processing unit. During operation, the processor 122 executes one or more programs 132 contained within the memory 124 and, as such, controls the general operation of the computer system 120, generally in executing the processes described herein, such as the process 300 discussed further below in connection with FIG. 3

The memory 124 can be any type of suitable memory. For example, the memory 124 may include various types of dynamic random access memory (DRAM) such as SDRAM, the various types of static RAM (SRAM), and the various types of non-volatile memory (PROM, EPROM, and flash). In certain examples, the memory 124 is located on and/or co-located on the same computer chip as the processor 122. In the depicted embodiment, the memory 124 stores the above-referenced program 132 along with one or more stored values 134 (e.g., including, in various embodiments, historical data as to driving patterns of the vehicles 150.

The bus 130 serves to transmit programs, data, status and other information or signals between the various components of the computer system 120. The interface 126 allows communication to the computer system 120, for example from a system driver and/or another computer system, and can be implemented using any suitable method and apparatus. The interface 126 can include one or more network interfaces to communicate with other systems or components. The interface 126 may also include one or more network interfaces to communicate with technicians, and/or one or more storage interfaces to connect to storage apparatuses, such as the storage device 128.

The storage device 128 can be any suitable type of storage apparatus, including various different types of direct access storage and/or other memory devices. In one exemplary embodiment, the storage device 128 comprises a program product from which memory 124 can receive a program 132 that executes one or more embodiments of one or more processes of the present disclosure, such as the steps of the process 300 discussed further below in connection with FIG. 3. In another exemplary embodiment, the program product may be directly stored in and/or otherwise accessed by the memory 124 and/or a disk (e.g., disk 136), such as that referenced below.

The bus 130 can be any suitable physical or logical means of connecting computer systems and components. This includes, but is not limited to, direct hard-wired connections, fiber optics, infrared and wireless bus technologies. During operation, the program 132 is stored in the memory 124 and executed by the processor 122.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 122) to perform and execute the program. Such a program product may take a variety of forms, and the present disclosure applies equally regardless of the particular type of computer-readable signal bearing media used to carry out the distribution. Examples of signal bearing media include: recordable media such as floppy disks, hard drives, memory cards and optical disks, and transmission media such as digital and analog communication links. It will be appreciated that cloud-based storage and/or other techniques may also be utilized in certain embodiments. It will similarly be appreciated that the computer system of the remote server 110 may also otherwise differ from the embodiment depicted in FIG. 1, for example in that the computer system 120 may be coupled to or may otherwise utilize one or more remote computer systems and/or other control systems.

In various embodiments, each vehicle 150 includes a drive system 151, a plurality of wheels 153, a location system 156, a plurality of sensors 157, and a computer system.

In certain embodiments, for each vehicle 150, the drive system 151 is mounted on a chassis (not depicted) and drives the wheels 153 (for example via axles, not depicted), for movement of the vehicle 150. The drive system 151 preferably comprises a propulsion system. In certain exemplary embodiments, the drive system 151 comprises an internal combustion engine and/or an electric motor/generator, coupled with a transmission thereof. In certain embodiments, the drive system 151 may vary, and/or two or more drive systems 114 may be used. By way of example, the vehicle 150 may also incorporate any one of, or combination of, a number of different types of propulsion systems, such as, for example, a gasoline or diesel fueled combustion engine, a “flex fuel vehicle” (FFV) engine (i.e., using a mixture of gasoline and alcohol), a gaseous compound (e.g., hydrogen and/or natural gas) fueled engine, a combustion/electric motor hybrid engine, and an electric motor.

In various embodiments, for each vehicle 150, the transceiver 155 is configured to communicate with the remote server 110, via its respective transceiver 115, along the communications network 190. For example, in various embodiments, the transceiver 155 provides location data from the vehicle 150 to the remote server 110. In addition, in various embodiments, the transceiver 155 receives instructions (e.g., routing instructions and communications instructions) from the remote server 110, along with information (e.g., traffic information) and/or other servers. Also in various embodiments, the vehicles 150 of the fleet communicate with one another using their respective transceivers 155 via the communications network 190 (e.g., with location data, routing instructions, communication instructions, and/or other information as appropriate in various embodiments).

Also in various embodiments, for each vehicle 150, the location system(s) 156 may include any number of location systems, global positioning systems (GPS), telematics mocules, GPS+telematics modules, and/or other systems that include the collecting and transmitting of location data for the vehicle 150. In certain embodiments, the location system 156 is part of a satellite-based system, such as a global position system (GPS), that provides location and heading information for the vehicle 150. Also in certain embodiments, the location and heading information comprises location data that is transmitted by the vehicles 150 to the remote server 110 (and, in certain embodiments, to the other vehicles 150) via the transceiver 155 using the communications network 190.

In various embodiments, the sensors 157 provide additional location data for the vehicle 150. For example, in certain embodiments, the sensors 157 include one or more cameras, radars, lidars, and/or other sensors for capturing information regarding an environment surrounding the vehicle 150, one or more speed-related sensors (e.g., wheel speed sensors, accelerometers, inertial measurement sensors, and so on) that provide information as to a velocity and/or movement of the vehicle 150, and/or one or more other sensors providing additional information with respect to the vehicle 150's travel. In various embodiments, this sensor information also comprises part of the location data that is transmitted by the vehicles 150 to the remote server 110 (and, in certain embodiments, to the other vehicles 150) via the transceiver 155 using the communications network 190.

Also in various embodiments, each vehicle 150 includes a computer system 160. In various embodiments, the computer system 160 is coupled to the other components of the vehicle 150 (e.g., the drive system 151, the transceiver 155, the location system 156, and the sensors 157), and controls operation thereof. Also in certain embodiments, the computer system 160 of one or more of the vehicles 150 provides functionality for one or more of the steps described with respect to the computer system 120 of the remote server 110, including the control and monitoring of the fleet 149 in a manner that conserves data and/or other resources using data transmission control based on vehicle densities, as described herein and depicted in the process 300 of FIG. 3. Also in various embodiments, for each vehicle 150, the computer system 160 includes a processor 162, memory 164 with programs 172 and stored values 174, interface 166, storage device 168, bus 170 (and in certain embodiments disk 176) that are similar in structure and function as the respective processor 122, memory 124 with programs 132 and stored values 134, interface 126, storage device 128, bus 130 (and in certain embodiments disk 136) as the remote server 110.

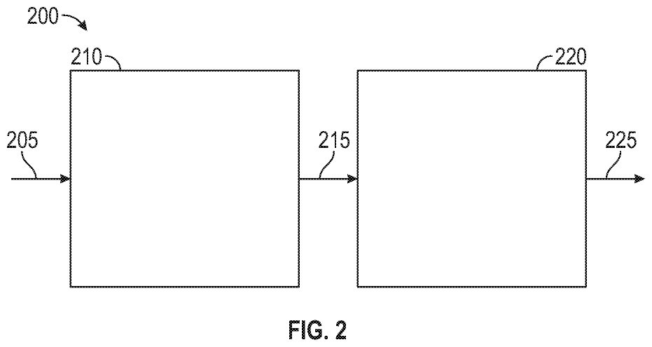

FIG. 2 is a functional diagram of modules of a control system 200 for monitoring a plurality of vehicles using location data, with controlled use of data and/or other resources, in accordance with various embodiments. In various embodiments, the control system 200 can be implemented in connection with one or more computer systems 120, 160 and/or other components of the remote server 110 and/or one or more of the vehicles 150, in accordance with exemplary embodiments.

As depicted in FIG. 2, in various embodiments, the control system 200 generally includes a data module 210 and a processing module 220. In certain embodiments, the data module 210 and processing module 220 are disposed within the remote server 110. In certain other embodiments, the data module 210 and the processing module 220 are disposed onboard one or more of the vehicles 150. In certain embodiments, the data module 210 and the processing module 220 (and/or components thereof) may be disposed at different locations (e.g., in certain embodiments, the data module 210 onboard a vehicle 150 and the processing module 220 within the remote server 110).

The data module 210 obtains location data for the vehicles 150, via one or more transceivers using the communications network 190. The data module 210 receives the location data as inputs 205 thereto, as depicted in FIG. 2.

In various embodiments, the data module 210 obtains geographic positions, headings, and routes of travel for the vehicles 150, based on data obtained from the location systems 156 of the vehicles 150 of the fleet 149. In certain embodiments, the data module 210 also obtains additional location data, such as images and/or other information as to roadways and a surrounding environment for the vehicle 150, including detected objects in proximity thereto, as well as information as to a velocity, acceleration, steering wheel angle, and/or other parameters for the vehicle 150. In certain embodiments, the various types of location data are transmitted by the vehicles 150 via the transceivers 155 via the communications network 190 and received by the transceiver 115 of the remote server 110 and provided to the computer system 120 thereof. In certain embodiments, the various types of location data are transmitted by the vehicles 150 to other vehicles 150 in the fleet 149 via their respective transceivers 155 via the communications network 190, and provided to the respective computer systems 160 thereof.

In various embodiments, the processing module 220 utilizes the location data from the data module 210 as inputs 215 for the processing module 220, and processes the inputs 215. Specifically, in various embodiments, the processing module 220 utilizes the various location data (e.g., described above) in providing routing instructions and traffic information, among other services, to the vehicles 150 in the fleet 149. Also in various embodiments, the processing module 220 utilizes the location data to monitor movement of the vehicles 150 in the fleet 149, and to control data transmissions by the vehicles 150 to conserve data and/or other resources based on traffic densities in particular regions (e.g., in particular road segments), for example to reduce or eliminate redundancies in the transmission of data by the vehicles 150 in the fleet 149. In various embodiments, the processing module 220 performs these steps in accordance with the steps of the process 300 depicted in FIG. 3 and described further below in connection therewith.

In various embodiments, the processing module 220 uses the determinations set forth above to provide instructions and information as outputs 225 as depicted in FIG. 2. Specifically, in various embodiments, the outputs 225 are provided to the vehicles 150. In various embodiments, the outputs 225 include routing instructions as well as communication instructions for the vehicles 150, as well as traffic information and/or other information for the vehicles 150, for example in accordance with the steps of the process 300 described below in connection with FIG. 3.

FIG. 3 is a flowchart of a process 300 for monitoring a plurality of vehicles using location data, with controlled use of data and/or other resources, in accordance with exemplary embodiments. In various embodiments, the process 300 can be implemented in connection with the system 100 of FIG. 1 (including the remote server 110, the vehicles 150, and the communications network 190 thereof) and the control system 200 of FIG. 2.

As depicted in FIG. 3, the process begins at 302. In certain embodiments, the process 300 begins when one or more of the vehicles 150 of FIG. 1 begin a vehicle drive or ignition cycle, for example when a driver approaches or enters the vehicle 150, or when the driver turns on the vehicle and/or an ignition therefor (e.g. by turning a key, engaging a keyfob or start button, and so on). In one embodiment, the steps of the process 300 are performed continuously during operation of the vehicles 150 in the fleet 149.

Location data is collected at 304. In various embodiments, location data is collected regarding a geographical position/location and heading for each of the vehicles 150 in the fleet 149 of FIG. 1 via the respective location systems 156 of the vehicles 150. Also in various embodiments, additional location data is also collected that includes camera images and/or other information regarding roadways an environment surrounding the vehicles 150, including detected objects in proximity thereto, as well as information as to a velocity, acceleration, steering wheel angle, and/or other parameters for the vehicles 150 (e.g., as obtained via respective sensors 157 of the vehicles 150).

In certain embodiments, the location data is collected via the data module 210 of FIG. 2. In addition, with reference to the system 100 of FIG. 1, in certain embodiments, the various types of location data are transmitted by the vehicles 150 by the transceivers 155 via the communications network 190 and received by the transceiver 115 of the remote server 110 and provided to the computer system 120 thereof. In certain other embodiments, the various types of location data are transmitted by the vehicles 150 to other vehicles 150 in the fleet 149 via their respective transceivers 155 via the communications network 190, and provided to the respective computer systems 160 thereof. Accordingly, while subsequent steps of the process 300 may be described below in connection with an implementation by the computer system 120 of the remote server 110, it will be appreciated that in other embodiments the steps may be performed, in whole or in part, by the computer system 160 of one or more of the vehicles 150.

In various embodiments, road segments are matched at 306. Specifically, in various embodiments, locations of each of the vehicles 150 are matched up with known road segments based on stored data, for example via the processor 122 of the remote server 110 (e.g., via the processing module 220 of FIG. 1) using stored values 134 of the memory 124 thereof, including map data. In certain other embodiments, this may be performed by respective processor(s) 162 of one or more of the vehicles 150.

In addition, in various embodiments, road speeds are aggregated from the location data at 308. For example, in certain embodiments, speeds of the various vehicles 150 are aggregated for the various road segments. In certain embodiments, the road speeds are aggregated based on the location data along with the matched road segments of 306. In certain embodiments, the road speeds are aggregated via the processor 122 of the remote server 110 (e.g., via the processing module 220 of FIG. 1). In certain other embodiments, this may be performed by respective processors 162 of one or more of the vehicles 150.

Traffic predictions are generated at 310. In various embodiments, the aggregated road speeds of 308 for the various regions (e.g., road segments) are utilized to generate traffic predictions for the various regions (e.g., road segments). In certain embodiments, the traffic predictions comprise estimates, for each road segment, for a number of vehicles 150 on the road segment, an average travel speed of vehicles 150 on the road segment, a length of time for vehicles 150 to travel along the roads between known points of the road segment, and so on. In certain embodiments, the traffic predictions are aggregated via the processor 122 of the remote server 110 (e.g., via the processing module 220 of FIG. 1). In certain other embodiments, this may be performed by respective processors 162 of one or more of the vehicles 150.

In various embodiments, routing services are generated at 312. In certain embodiments, the routing services include information, for each of vehicle 150 in the fleet 149, as to: (i) a destination for travel for a particular vehicle 150; (ii) a selected path for travel to the destination; and (iii) traffic conditions that are likely to be encountered by the vehicle 150 along the selected path en route to the destination. In certain embodiments, the traffic predictions are aggregated via the processor 122 of the remote server 110 (e.g., via the processing module 220 of FIG. 1). In certain other embodiments, this may be performed by respective processors 162 of one or more of the vehicles 150. Also in certain embodiments, additional or related services may be provided, such as information as to an amount of time expected to reach the destination, potential stopping points along the way (e.g., for fuel, food, lodging, or the like), and/or other information.

Also in various embodiments, the routing services of 312 are provided via transmissions to the vehicles 150 at 313. In certain embodiments, the routing instructions (e.g., the destination and selected route) are transmitted, along with related information (e.g., traffic information and/or other information, for example as noted above) to the vehicles 150 from the transceiver 115 of the remote server 110 via the communications network 190. In certain embodiments, certain of the instructions and/or information may be instead transmitted between different vehicles 150 using the communications network 190 and respective transceivers 155 thereof.

Additionally, in certain embodiments, the vehicles 150 may make certain routing requests to the remote server 110 (or, in some embodiments, to other vehicles 150). For example, in certain embodiments, a vehicle 150 (or an operator thereof) may make a particular request to the remote server 110 for a particular type of destination (e.g., a refueling request to find a nearby gas station, among various other possibilities), and the remote server 110 may then select an appropriate destination (e.g., a particular gas station location) and/or a particular route to the destination, and so on.

Also in various embodiments, the routing services generated at 312 are also stored in memory as historical data at 314. For example, in various embodiments, the memory 124 of the remote server 110 stores the various routes utilized by the various vehicles 150 over time as stored values 134 therein, for use at a future point in time (e.g., for use in subsequent drive cycles). In certain embodiments, this may be performed by memory 164 of one or more respective vehicles 150.

In various embodiments, the current routing services of 312 and the historical data of 314 are utilized at 315 to generate both live and historical fleet routes for each vehicle 150 in the fleet 149. For example, in certain embodiments, for each particular vehicle 150, a current route is generated based on current travel and/or current routing instructions for the vehicle 150, along with previous routes for the vehicle 150 based on the historical data for the vehicle 150, as well as histories of other vehicles traversing through the same region, including a general history of vehicles traversing the same region. In certain embodiments, this information is generated by the processor 122 of the remote server 110 and stored in the memory 124 of the remote server 110 as stored values 134 thereof. Alternatively, in certain embodiments, this may be performed by respective processor(s) 162 and memory 164 of one or more of the vehicles 150.

Returning back to 304, in certain embodiments the location data of 304 is also used at 316 to generate additional information regarding the location and speed of the vehicles 150 in the fleet 149. Specifically, in various embodiments, locations and speeds of each of the vehicles 150 are aggregated together at 316 to generate comprehensive information regarding the speed and position of each of the vehicles 150 in the fleet 149. In certain embodiments, this is performed by the processor 122 of the remote server 110 (e.g., via the processing module 220 of FIG. 1) using the location data of 304. In certain other embodiments, this may be performed by respective processor(s) 162 of one or more of the vehicles 150.

In various embodiments, at 318, the comprehensive location and speed information for the fleet 149 of 316 is used, along with the live and historic routes of 315, to generate an expected trajectory for each of the vehicles 150 in the fleet 149. For example, in certain embodiments, for each particular vehicle 150, the trajectory estimate may be based on past travelling tendencies for the vehicle 150 based on a particular day of the week, time of day, or the like, and/or based on past travelling tendencies for the vehicle 150 as well as other vehicles making similar journeys, based on previous circumstances resembling the current conditions for the routing services, and so on. In certain embodiments, this is performed by the processor 122 of the remote server 110. Alternatively, in certain embodiments, this may be performed by respective processor 162 of one or more of the vehicles 150.

In various embodiments, future densities are estimated at 320. In certain embodiments, a “future density” refers to an expected density of vehicles 150 of the particular fleet 149 that are expected to be travelling on a particular road segment at a particular time. For example, in certain embodiments, this may refer to a number of such vehicles in the fleet travelling on a particular road segment, and/or a number of such vehicles in the fleet travelling per square unit of distance (e.g., square mile or square kilometer) of the road segment, and so on. In various embodiments, future densities are estimated for a future point in time for various regions of travel based on the vehicle trajectory estimates of 318. For example, in certain embodiments, future densities are estimated for various road segments based on how many of the vehicles 150 of the fleet 149 are expected to be travelling along each particular road segment at the future point in time, based on the vehicle trajectory estimates of 318 (e.g., based on current trajectories of the vehicles 150 along with the historical data as to previous activity and travel of the vehicles 150 for similar days of the week, times of the day, geographic locations, current routes, and so on).

Also in various embodiments, as part of 320, for each particular road segment (or other region), a determination is made as to a group of specific vehicles 150 of the fleet 149 that are expected to be travelling along the particular road segment at the particular future point in time, and the density for the particular road segment is calculated by totaling the number of vehicles 150 in that group. In various embodiments, this is performed by the processor 122 of the remote server 110. Alternatively, in certain embodiments, this may be performed by respective processor 162 of one or more of the vehicles 150.

In various embodiments, redundant vehicles are selected at 322. In various embodiments, for each particular road segment (or other region), the group of vehicles 150 determined at 320 is separated into two subsets, namely: (i) a first subset that is to continue transmitting location data for future iterations of 304; and (ii) a second subset that is to discontinue or reduce frequency of transmitting location data (at least for a certain period of time) for future iterations of 304.

In certain embodiments, for a particular road segment (or other region), the size of the first and second subsets are based on the density of vehicles 150 of the fleet 149 that are travelling along the particular road segment, such that a predetermined number of vehicles 150 (i.e., the first subset) continues the transmission of data for the particular region for the particular time, without redundant transmission of vehicles 150 beyond the predetermined number of vehicles 150. For example, in certain embodiments, transmission of location data may be desired for “X” number of vehicles 150 per mile of a particular road segment. If the total number of vehicles 150 expected to be on the road segment exceeds “X” (e.g., if the total number of vehicles 150 expected to be on the road segment is equal to “Y”, with “Y” being greater than “X”), then “X” vehicles 150 are selected to be in the first subset, with the remaining vehicles 150 (i.e., totaling “Y”−“X” vehicles 150) are selected to be in the second subset. Also in various embodiments, the specific vehicles 150 selected for the first and second subsets are selected based on random assignment (e.g., using a random number generator), within the constraints set forth above with the respect to the number of vehicles 150 in each subset, via the processor 122 of the remote server 110. Alternatively, in certain embodiments, this may be performed by respective processor 162 of one or more of the vehicles 150.

In various embodiments, data communication instructions are transmitted at 324. In various embodiments, instructions are provided to the vehicles 150 as to whether and/or how to continue or discontinue location data transmissions. In certain embodiments, the remote server 110 of FIG. 1 provides the instructions at 324 via the transceiver 115 along the communications network 190. In certain other embodiments, one or more vehicles 150 of the fleet 149 provide the instructions to one or more other vehicles 150 via respective transceivers 155, and/or to one or more systems of the same vehicle 150 (e.g., via a vehicle communications bus).

In certain embodiments, for each particular road segment (or other region), (i) the first subset of the group of vehicles 150 of 322 are provided instructions to continue transmission of location data in subsequent iterations of 304; and (ii) the second subset of the group of vehicles 150 of 322 are provided instructions to discontinue transmission of location data in subsequent iterations of 304. In certain embodiments, each vehicle 150 in the second subset receives instructions to discontinue location data transmissions for a predetermined amount of time (e.g., an amount of time in which the vehicle 150 is expected to be travelling along the road segment), and then to re-commence location data transmissions after the predetermined amount of time (while vehicles 150 in the first subset are instructed to continue location data transmissions as normal during the entire time). In certain other embodiments, each vehicle 150 in the second subset receives instructions to continue location data transmissions less frequently for the predetermined amount of time (while vehicles 150 in the first subset are instructed to continue location data transmissions at their normal rates).

In certain other embodiments, each vehicle 150 in the second subset receives instructions to discontinue location data transmissions (or to reduce the frequency of such transmissions) indefinitely until subsequent instructions are received to revert back to their normal location data transmissions. Also in certain embodiments, when a particular vehicle 150 previously had location data transmissions discontinued (or the frequency reduced) and additional communications are now warranted (e.g., due to the vehicle 150 exiting the high density (e.g, referring to the expected density of vehicles in the fleet travelling along a particular road segment at a particular point in time, per the discussion above with respect to “future density”) road segment, or the density of the road segment being reduced), then instructions are provided at 324 to such vehicle 150 to re-commence location data transmissions and/or to increase the frequency of such transmissions, as appropriate.

Accordingly, in various embodiments, the instructions at 324 help to ensure that sufficient location data transmissions continue for each road segment, while also reducing or eliminating excess redundancy beyond the desired number of transmissions. This may help to conserve data transmission resources for the fleet 149, and may also help to conserve other resources as well (e.g., operator time in assisting with and/or reviewing transmissions, energy usage, and so on).

Also in certain embodiments, a determination as made at 328 as to whether additional monitoring and control of the fleet 149 are required. In certain embodiments, the processor 122 of the remote server 110 of FIG. 1 (and/or more processors 162 of vehicles 150 of FIG. 1) make a determination as to whether any vehicles 150 in the fleet 149 are travelling. In certain embodiments, if monitoring and control are still required (e.g., if the vehicles 150 are still travelling), then the process returns to 304 for a new iteration. Conversely, also in certain embodiments, if monitoring and control are not required, then the process terminates at 330.

Accordingly, methods and system are provided for monitoring a plurality of vehicles using location data. In various embodiments, usage of data transmission resources and/or other resources are controlled by randomly selecting certain vehicles to continue transmitting location data, and certain other vehicles to discontinue transmitting location data (or the frequency thereof). Also in various embodiments, this selection is performed based on a density of a particular region (e.g., a particular road segment) based on projected future locations of the vehicles, for example using historical data and/or other information. As a result, certain redundant transmissions may be eliminated or reduced, thereby providing potential reductions in usage of data and/or other resources, including for example by reducing minimizing data that need to be transmitted for estimating traffic conditions for a fleet of vehicles.

It will be appreciated that the systems and methods may vary from those depicted in the Figures and described herein. For example, the system of FIG. 1, including the remote server, the vehicles, the communication network, and/or components thereof, may vary from that depicted in FIG. 1 and/or described herein, in various embodiments. It will similarly be appreciated that the control system of FIG. 2, including the modules thereof, and/or components thereof, may vary from that depicted in FIG. 2 and/or described herein, in various embodiments. It will also be appreciated that the processes (and/or subprocesses) disclosed herein may differ from those described herein and/or depicted in FIG. 3, and/or that steps thereof may be performed simultaneously and/or in a different order as described herein and/or depicted in FIG. 3, among other possible variations.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof

What is claimed is:

1. A method comprising:
obtaining, via a transceiver, location data from a plurality of vehicles pertaining to a location of each of the vehicles, from transmission from the plurality of vehicles;
determining, via a processor, a group of the plurality of vehicles that are expected to be disposed within a particular region at a particular time;
calculating, via the processor, a density of vehicles for the particular region for the particular time, based on the determined group of vehicles;
selecting, via the processor, a subset of the group of the plurality of vehicles for continued transmission of data, based on the density of vehicles; and
providing instructions, via the processor for transmission via the transceiver, for selective continuing or discontinuing of subsequent transmission of location data from certain of the group of the plurality of vehicles, based on whether each of the group of the plurality of vehicles is part of the subset.

2. The method of claim 1, further comprising:
obtaining historical data as to travel routes taken by the plurality of vehicles at previous times; and
predicting, via the processor, future locations of the plurality of vehicles at a future point time based on the location data and the historical data;
wherein the step of determining the group of the plurality of vehicles that are expected to be disposed within the particular region at the particular time comprises determining, via the processor, the group of the plurality of vehicles that are expected to be disposed within the particular region at the particular time, based on the predicting of the future locations.

3. The method of claim 1, further comprising:
obtaining routing requests for the plurality of vehicles;
wherein the step of determining the group of the plurality of vehicles that are expected to be disposed within the particular region at the particular time comprises determining, via the processor, the group of the plurality of vehicles that are expected to be disposed within the particular region at the particular time, based on the obtained routing requests.

4. The method of claim 1, wherein:
the step of selecting the subset comprises selecting, via the processor, the group of the plurality of vehicles for continued transmission of data, at random, based on the density of vehicles, such that a predetermined number of vehicles continues the transmission of data for the particular region for the particular time, without redundant transmission of vehicle beyond the predetermined number of vehicles.

5. The method of claim 1, wherein the step of providing instructions comprises:
providing instructions, via the processor using the transceiver, for all vehicles in the group that are not part of the subset, for selective discontinuing of subsequent transmission of location data.

6. The method of claim 1, wherein the step of providing instructions comprises:
providing instructions, via the processor for transmission via the transceiver, for all vehicles in the group that are part of the subset, for selective continuing of subsequent transmission of location data.

7. The method of claim 1, wherein the obtaining, determining, calculating, selecting, and providing instructions are provided via a computer system that is part of a central server that is remote from and in communication with the plurality of vehicles.

8. The method of claim 1, wherein the obtaining, determining, calculating, selecting, and providing instructions are provided via a computer system that is onboard one of the plurality of vehicles.

9. A system comprising:
a data module configured to obtain, via a transceiver, location data from a plurality of vehicles pertaining to a location of each of the vehicles, from transmission from the plurality of vehicles; and
a processing module configured to:
determine, via a processor, a group of the plurality of vehicles that are expected to be disposed within a particular region at a particular time;
calculate, via the processor, a density of vehicles for the particular region for the particular time, based on the determined group of vehicles;
select, via the processor, a subset of the group of the plurality of vehicles for continued transmission of data, based on the density of vehicles; and
provide instructions, via the processor for transmission via the transceiver, for selective continuing or discontinuing of subsequent transmission of location data from certain of the group of the plurality of vehicles, based on whether each of the group of the plurality of vehicles is part of the subset.

10. The system of claim 9, wherein:
the data module is configured to obtain historical data as to travel routes taken by the plurality of vehicles at previous times; and
the processing module is configured to:
predict, via the processor, future locations of the plurality of vehicles at a future point time based on the location data and the historical data; and
determine, via the processor, the group of the plurality of vehicles that are expected to be disposed within the particular region at the particular time, based on the predicting of the future locations.

11. The system of claim 9, wherein:
the data module is configured to obtain routing requests for the plurality of vehicles; and
the processing module is configured to determine, via the processor, the group of the plurality of vehicles that are expected to be disposed within the particular region at the particular time, based on the obtained routing requests.

12. The system of claim 9, wherein the processing module is configured to select, via the processor, the group of the plurality of vehicles for continued transmission of data, at random, based on the density of vehicles, such that a predetermined number of vehicles continues the transmission of data for the particular region for the particular time, without redundant transmission of vehicle beyond the predetermined number of vehicles.

13. The system of claim 9, wherein the processing module is configured to provide instructions, via the processor for transmission via the transceiver, for all vehicles in the group that are not part of the subset, for selective discontinuing of subsequent transmission of location data.

14. The system of claim 9, wherein the processing module is configured to provide instructions, via the processor for transmission via the transceiver, for all vehicles in the group that are part of the subset, for selective continuing of subsequent transmission of location data.

15. The system of claim 9, wherein the data module and the processing module are part of a computer system that is part of a central server that is remote from and in communication with the plurality of vehicles.

16. The system of claim 9, wherein the data module and the processing module are part of a computer system that is onboard one of the plurality of vehicles.

17. A computer system comprising:
a transceiver disposed on a remote server that is remote from a plurality of vehicles and configured to obtain location data from the plurality of vehicles pertaining to a location of each of the vehicles, from transmission from the plurality of vehicles; and
a processor disposed on the remote server and configured to:
determine a group of the plurality of vehicles that are expected to be disposed within a particular region at a particular time;
calculate a density of vehicles for the particular region for the particular time, based on the determined group of vehicles;
select a subset of the group of the plurality of vehicles for continued transmission of data, based on the density of vehicles; and
provide instructions for selective continuing or discontinuing of subsequent transmission of location data from certain of the group of the plurality of vehicles, based on whether each of the group of the plurality of vehicles is part of the subset;
wherein the transceiver is further configured to transmit the instructions from the processor to the plurality of vehicles.

18. The computer system of claim 17, wherein:
the transceiver is configured to obtain historical data as to travel routes taken by the plurality of vehicles at previous times; and
the processor is configured to:
predict future locations of the plurality of vehicles at a future point time based on the location data and the historical data; and
determine the group of the plurality of vehicles that are expected to be disposed within the particular region at the particular time, based on the predicting of the future locations.

19. The computer system of claim 17, wherein the processor is configured to select the group of the plurality of vehicles for continued transmission of data, at random, based on the density of vehicles, such that a predetermined number of vehicles continues the transmission of data for the particular region for the particular time, without redundant transmission of vehicle beyond the predetermined number of vehicles.

20. The computer system of claim 17, wherein:
the processor is configured to:
provide first instructions for all vehicles in the group that are not part of the subset, for selective discontinuing of subsequent transmission of location data; and
provide second instructions for all vehicles in the group that are part of the subset, for selective continuing of subsequent transmission of location data; and
the transceiver is configured to transmit the first instructions and the second instructions to the plurality of vehicles.
